(19) United States
(12) Patent Application Publication
(10) Pub. No.: US 2020/0110586 A1
(43) Pub. Date: Apr. 9, 2020

(54) PROGRAM DEVELOPMENT SYSTEM AND DEVELOPMENT METHOD USING THE SAME

(71) Applicant: ENTERPHIN CO., LTD., Seoul (KR)

(72) Inventors: Min Uk KIM, Seoul (KR); Seok Jung KIM, Seoul (KR); Chae Yun KIM, Seoul (KR); Geun Ho YANG, Yangpyeong-gun (KR); Chan Hyeok IM, Namyangju-si (KR); Sung Ku CHO, Daejeon (KR)

(73) Assignee: ENTERPHIN CO., LTD., Seoul (KR)

(21) Appl. No.: 16/582,116

(22) Filed: Sep. 25, 2019

(30) Foreign Application Priority Data
Oct. 5, 2018 (KR) 10-2018-0118650

(51) Int. Cl. G06F 8/36; G06F 8/70; G05B 19/042

(52) U.S. Cl. CPC G06F 8/36; G05B 19/0426; G06F 8/70

(57) ABSTRACT

Provided are a program development system and a development method using the same. The program development system for driving a hardware device includes a module selecting unit configured to select a module component through a user interface; a module setting unit configured to input, through the user interface, a hardware configuration of the module component selected by the module selecting unit; a library unit configured to store a module code related to the module component; and a code generating unit configured to generate a driving code for driving the hardware device.

### CROSS-REFERENCE TO RELATED APPLICATION

This application claims the benefit of Korean Patent Application No. 10-2018-0118650, filed on Oct. 10, 2018, in the Korean Intellectual Property Office, the disclosure of which is incorporated herein in its entirety by reference.

### BACKGROUND

### 1. Field

One or more embodiments relate to a program development system and a development method using the same, and more particularly, to a program development system for developing a program of performing a specific function for control on a system to be controlled and a development method using the program development system.

### 2. Description of the Related Art

When a development project of developing a hardware device is carried out, a developer tries to find a module component compatible with a main board according to development intention and having appropriate performance and low production costs. To this end, the developer spends a lot of time finding an appropriate module component by searching for many module components and reviewing data sheets. Also, to develop a program for driving the hardware device, the developer studies a data sheet of each module component and undergoes trials and errors.

Even though the developer has spent a lot of time, when the main board is replaced during the development project, the developer has to change all program codes so that the program codes are compatible with a new microcontroller. It is like starting the development project from scratch. It is a waste of resources that have been consumed so far. It is necessary to prevent a waste of resources in a hardware device development stage.

### SUMMARY

To solve the above problems, an objective of the present disclosure is to build a database of module codes of module components in a hardware device development stage and automatically perform a setting operation between a module component and a main board by using simple pin assignment through a user interface.

Also, an objective of the present disclosure is to enable only a module component and a pin of the module component compatible with a main board to be selected and reduce trials and errors in a development stage.

Additional aspects will be set forth in part in the description which follows and, in part, will be apparent from the description, or may be learned by practice of the presented embodiments.

According to one or more embodiments, a program development system for driving a hardware device including a main board on which a microcontroller is mounted and at least one module component electrically connected to the main board includes: a module selecting unit configured to select the module component through a user interface; a module setting unit configured to input, through the user interface, a hardware configuration of the module component selected by the module selecting unit; a library unit configured to store a module code related to the module component; and a code generating unit configured to generate a driving code for driving the hardware device.

The code generating unit may be further configured to automatically generate the driving code by using the module code stored in the library unit, and automatically reflect the hardware configuration input by the module setting unit in the driving code.

The hardware configuration may include assigning each pin of the selected module component to each pin of the main board or the microcontroller.

When the pin of the main board or the microcontroller assigned to the pin of the selected module component is changed, the module code may be changed according to changed pin assignment.

The module setting unit may allow only a pin of the main board or the microcontroller that is assignable to the pin of the selected module component to be selected.

The hardware configuration may include assigning an input/output unit of the module component to an input/output unit of the microcontroller.

The module code may be automatically generated when the hardware configuration is completed in the module setting unit.

The module selecting unit may allow only a module component compatible with a type of the main board to be selected.

The program development system may further include a code converting unit configured to change the driving code that is written into a code compatible with the main board or the microcontroller, according to the main board or the microcontroller.

The library unit may be further configured to store the module code in an external server connected to a network.

The program development system may further include a state display unit configured to display as graphics a connection state between the main board and the module component connected to the main board.

The hardware configuration may include assigning each pin of the selected module component to each pin of the main board or the microcontroller, wherein the module setting unit is further configured to provide an alarm when each pin of the module component is redundantly assigned to each pin of the main board or the microcontroller.

The alarm may be generated when the pin of the main board or the microcontroller is selected for the pin of the selected module component.

The alarm may be displayed on the state display unit at a position of a pin that is redundantly assigned.

The program development system may further include a hardware diagnosing unit configured to upload a diagnostic program, which is pre-written to diagnose a connection state of the hardware device, to the hardware device.

According to one or more embodiments, a program development system for driving a hardware device including a main board on which a microcontroller is mounted and at least one module component electrically connected to the main board includes: a module selecting unit configured to select the module component; a module setting unit configured to set each pin of the module component selected by the module selecting unit to each pin of the microcontroller or the main board through a user interface; and a code generating unit configured to automatically generate a driving code for driving the hardware device including the module component selected by the module selecting unit, wherein the code generating unit is further configured to generate the driving code by using information of each pin of the module component set by the module setting unit.

Each pin of the module component and each pin of the microcontroller or the main board may be pins related to input/output.

According to one or more embodiments, a program development method using a program development system for driving a hardware device including a main board on which a microcontroller is mounted and at least one module component electrically connected to the main board includes: a module selecting step of selecting the module component; a module setting step of inputting, through a user interface, a hardware configuration of the module component selected in the module selecting step; and a code generating step of generating a driving code for driving the hardware device, wherein the code generating step includes automatically generating the driving code by using a pre-written module code related to the module component and automatically generating the hardware configuration input in the module setting step in the driving code.

The hardware configuration may include assigning each pin of the selected module component to each pin of the main board or the microcontroller.

The hardware configuration may include assigning each pin of the selected module component to each pin of the main board or the microcontroller, wherein the module setting step includes providing an alarm when each pin of the module component is redundantly assigned to each pin of the main board or the microcontroller.

The program development method may further include a hardware diagnosing step of uploading a diagnostic program, which is pre-written to diagnose a connection state of the hardware device, to the hardware device.

According to one or more embodiments, a computer-readable recording medium having embodied thereon a program for executing the method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating a configuration of a program development system according to an embodiment of the present disclosure;

FIG. 2 is a block diagram illustrating elements of a hardware device according to an embodiment of the present disclosure;

FIG. 3 is a diagram illustrating an example where a module selecting unit selects a module component through a user interface according to an embodiment of the present disclosure;

FIG. 4 is a diagram illustrating an example where a module setting unit performs a hardware configuration through a user interface according to an embodiment of the present disclosure;

FIG. 5 is a diagram illustrating a driving code according to an embodiment of the present disclosure;

FIG. 6 is a diagram illustrating a driving code into which a driving code generated by a code generating unit is inserted according to an embodiment of the present disclosure;

FIG. 7 is a diagram illustrating a change in a driving code according to a change in a hardware configuration;

FIG. 8 is a diagram illustrating a module code connected to the generated driving code of FIG. 6 according to an embodiment of the present disclosure;

FIG. 9 is a block diagram of a program development system further including a code converting unit according to an embodiment of the present disclosure;

FIG. 10 is a block diagram of a program development system connected to a network according to an embodiment of the present disclosure;

FIG. 11 is a block diagram of a program development system including a state display unit according to an embodiment of the present disclosure;

FIG. 12 is a diagram illustrating graphics displayed on the state display unit according to an embodiment of the present disclosure;

FIG. 13 is a diagram illustrating an alarm that is redundantly assigned in a hardware configuration process according to an embodiment of the present disclosure;

FIG. 14 is a block diagram of a program development system including a hardware diagnosing unit according to an embodiment of the present disclosure;

FIG. 15 is a flowchart of a program development method according to an embodiment of the present disclosure;

FIG. 16 is a flowchart of a program development method including a hardware diagnosing step according to an embodiment of the present disclosure; and

FIG. 17 is a flowchart of a program development method including a redundant pin assignment detecting step according to an embodiment of the present disclosure.

### DETAILED DESCRIPTION

Hereinafter, principles and embodiments of the present disclosure will be described in detail in order to fully convey the scope of the present disclosure and enable one of ordinary skill in the art to embody and practice the present disclosure. However, the present embodiments may have different forms and should not be construed as being limited to the descriptions set forth herein. Parts in the drawings unrelated to the detailed description are omitted to ensure clarity of the present disclosure.

The terms used in the present specification are merely used to describe exemplary embodiments, and are not intended to limit the present disclosure. An expression used in the singular encompasses the expression of the plural, unless it has a clearly different meaning in the context.

In the present specification, it is to be understood that the terms such as “including”, “having”, and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Further, components described in the embodiments of the present disclosure are independently illustrated in order to show different characteristic functions and each component is not constituted by separated hardware or one software constituting unit. That is, each component includes respective components which are arranged for easy description and at least two components of the respective components may constitute one component or one component is divided into a plurality of components which may perform their functions. Even an integrated embodiment and separated embodiments of each component are also included in the scope of the present disclosure without departing from the spirit of the present disclosure.

Also, the following embodiments are provided so that this disclosure will be thorough and complete, and will fully convey the present disclosure to one of ordinary skill in the art, and in the drawings, shapes and sizes of elements may be exaggerated for clarity.

The present disclosure will now be described more fully with reference to the accompanying drawings, in which embodiments of the disclosure are shown.

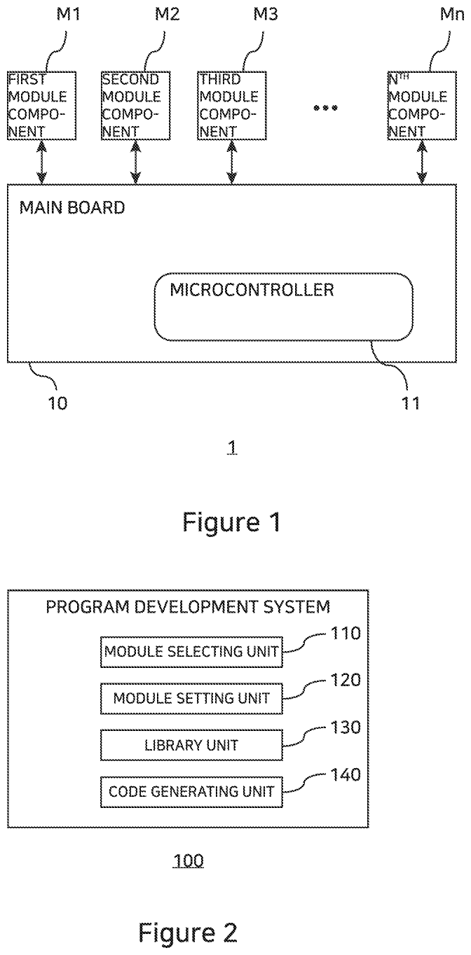

FIG. 1 is a block diagram illustrating elements of a program development system according to an embodiment of the present disclosure. FIG. 2 is a block diagram illustrating elements of a hardware device according to an embodiment of the present disclosure.

Referring to FIGS. 1 and 2, a program development system 100 according to an embodiment of the present disclosure is a system for driving a hardware device 1 including a main board 10 on which a microcontroller 11 is mounted and one or more module components M1, M2, M3, . . . , and Mn electrically connected to the main board 10.

The program development system 100 may include a module selecting unit 110 for selecting the module components M1, M2, M3, . . . , and Mn, a module setting unit 120 for inputting a hardware configuration of the module components M1, M2, M3, . . . , and Mn selected by the module selecting unit 110 through a user interface, a library unit 130 for storing module codes related to the module components M1, M2, M3, . . . , and Mn, and a code generating unit 140 for generating a driving code for driving the hardware device 1.

The code generating unit 140 may automatically generate the driving code by using the mode codes stored in the library unit 130 and may automatically reflect the hardware configuration input by the module setting unit 120 in the driving code.

The hardware device 1 according to an embodiment of the present disclosure may be a device in which the one or more module components M1, M2, M3, . . . , and Mn are electrically connected to the main board 10 on which the microcontroller 11 is mounted to perform a specific function. The hardware device 1 having a driving program or a control program installed therein without a separate operating system may perform only a designed specific function or a specific task. A function performed by the hardware device 1 may vary according to functions of the module components M1, M2, M3, . . . , and Mn electrically connected to the main board 10. Examples of the hardware device 1 may include a simple device such as an electronic clock capable of providing an alarm according to a mount time, an electronic scale, a device using an ultrasonic sensor, a device using a illumination sensor, a motor driving device, a device using a proximity sensor, or an electronic calculator and a high-level device such as a smartphone, a smart TV, or medical equipment.

In the simple device, the microcontroller 11 having low performance and a low-capacity memory may be mounted on the main board 10. In the high level device, the microcontroller 11 having relatively high performance to perform various functions and a high-capacity memory may be mounted, and an operating system may be mounted.

One or more module components M1, M2, M3, . . . , and Mn may be connected to the main board 10. When a module component is connected to the main board 10, it may mean that a signal or power may be electrically transmitted/received between the module component and the main board 10, and the module component may be physically connected to the main board 10 or may not be physically connected to the main board 10. For example, when the main board 10 and a certain module component are connected to each other wirelessly and a signal is transmitted/received therebetween, it may mean that the main board 10 and the certain module component are connected to each other.

The module components M1, M2, M3, . . . , and Mn may be components additionally connected to the hardware device 1 and configured to perform a specific function. The hardware device 1 may include at least one module component M1, M2, M3, . . . , and Mn. In general, the module components M1, M2, M3, . . . , and Mn may be manufactured to perform one function or may be manufactured to perform one or more functions. The module components M1, M2, M3, . . . , and Mn may be connected to the main board 10 and may operate according to a control signal of the microcontroller 11 mounted on the main board 10. The module components M1, M2, M3, . . . , and Mn may transmit a result of their operations according to the control signal of the microcontroller 11 again to the main board 10 or the microcontroller 11.

The module components M1, M2, M3, . . . , and Mn may include a communication module, a sensor module, an audio output module, a data conversion module, an auxiliary memory module, a sensor module having various functions, a rectifying element, a motor, a display module, and an antenna.

A program or software for driving the hardware device 1 may be divided into a driving code and a module code. The driving code may be a main code for directly controlling the hardware device 1, and the module code may be an auxiliary code dependently included in the driving code.

For example, a unique function of a module component for sensing an ambient temperature such as a temperature sensor is designed by using hardware or implemented by using software by a manufacturer of the module component. The manufacturer provides input/output signal information of the module component as a data sheet to a buyer. A function of the main board 10 on which the microcontroller 11 is mounted may be implemented, like that of the module component. Like the module component, input/output signal information related to the microcontroller 11 mounted on the main board 10 and other components and instruction information for controlling the microcontroller 11 are provided as a data sheet, a document, or a file to the buyer.

A developer may view the data sheet and may write a code to use each module component connected to the main board 10. The developer may write a code that controls and operates the hardware device 1 according to an algorithm designed and intended by the developer during code writing. The code that controls and operates the hardware device 1 may be referred to as a driving code.

When the developer writes the driving code, a code such as a variable or a function repeatedly used for any one module component may be included. The code such as the variable or the function repeatedly used for the one module component is separately generated as another code file and, when necessary for the driving code, may be connected to the driving code and may be dependently used. The code that is pre-written for the one module component may be referred to as a module code.

The module code may include information about the module component. The information about the module component may include a category, a model, a manufacturer, a function, the number of pins, and a type of the pins (input pins or output pins), etc. of the module component. Such a module code corresponding to each module component may be stored in the library unit 130.

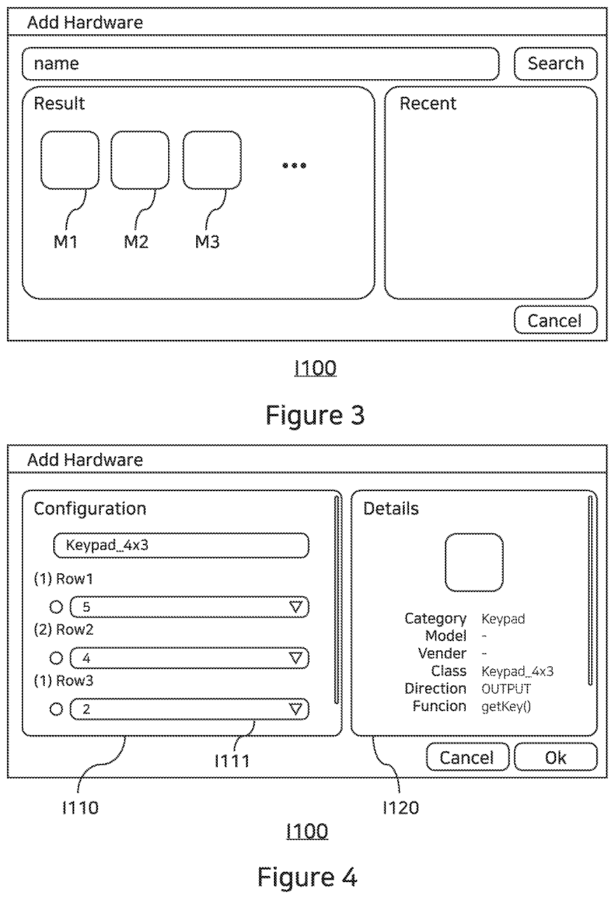

FIG. 3 is a diagram illustrating an example where a module selecting unit selects a module component through a user interface according to an embodiment of the present disclosure.

Referring to FIG. 3, the module selecting unit 110 may select the module components M1 and M2 to be connected to the main board 10 through a user interface I100. The module components M1, M2, M3, . . . , and Mn displayed on the user interface I100 are registered module components. The module components M1, M2, M3, . . . , and Mn registered in the program development system 100 may all be displayed on the user interface I100 and may be selected. The term ‘registered module component’ refers to a module component whose module code is stored in the library unit 130 and may be used in a driving code.

In another embodiment, when the module selecting unit 110 selects the module components M1, M2, M3, . . . , and Mn through the user interface I100, only some of the module components M1, M2, M3, . . . , and Mn which are compatible with the main board 10 may be displayed on the user interface I100. For example, when module components registered in the program development system 100 are M1 to M10, only the module components M1, M3, and M10 compatible with the main board 10 may be displayed on the user interface I100. When the main board 10 is replaced with a new main board, only the module components M2, M4, and M6 compatible with the new main board may be displayed.

Alternatively, all of the module components M1, M2, M3, . . . , and Mn registered in the program development system 100 may be displayed, and only some of the module components M1, M2, M3, . . . , and Mn compatible with the main board 10 may be selected. For example, when the module components registered in the program development system 100 are M1 to M10 as described above, the module components M1 to M10 may all be displayed on the user interface I100 and only the module components M1, M3, and M10 compatible with the main board 10 may be selected. When the main board 10 is replaced with a new main board, module components that may be selected may be changed. For example, only the module components M2, M4, and M6 compatible with the new main board may be selected.

In the prior art, a developer spends time searching for types of module components necessary to perform an intended function, and checking and reviewing data sheets to determine whether the module components M1, M2, M3, . . . , and Mn to be connected to the main board 10 to be used are compatible with the main board 10. However, the program development system 100 according to the present disclosure may easily check whether the module components M1, M2, M3, . . . , and Mn that are registered module components are compatible with the main board 10 and may select only compatible module components, thereby reducing the time mentioned above.

FIG. 4 is a diagram illustrating an example where a module setting unit performs a hardware configuration through a user interface according to an embodiment of the present disclosure.

Referring to FIG. 4, a hardware configuration of selected module components may be performed through the user interface I100. The hardware configuration may include assigning each pin of the selected module components M1, M2, M3, . . . , and Mn to each pin of the main board 10 or the microcontroller 11. The term ‘pin’ may refer to a physical contact point for transmitting/receiving a signal, data, or power.

The main board 10 and the module components M1, M2, M3, . . . , and Mn may have pins for transmitting/receiving a signal according to a hardware design. A developer generates a signal path between the main board 10 and the module components M1, M2, M3, . . . , and Mn by connecting pins of the module components M1, M2, M3, . . . , and Mn to a pin of the main board 10 according to his/her intention. In the prior art, for such pin assignment, the developer directly writes and assigns a code. In this case, the developer writes a code by checking a data sheet of the main board 10 and a data sheet of each of module components to be connected to the main board 10 one by one. The developer checks the number of pins of the module components to be connected to the main board 10, and whether the pins are analog input pins or output pins, or digital input pins or output pins. Accordingly, a time spent on one module component increases as the number of module components to be connected to the main board 10 increases.

However, in the present disclosure, a pin of the main board 10 corresponding to each pi of a module component may be assigned to a pin of the main board 10 by using the user interface I100. A hardware configuration through the user interface I100 may be reflected in a driving code generated by the code generating unit 140 of FIG. 1.

The hardware configuration may include assigning input/output units of the module components M1, M2, M3, . . . , and Mn to an input/output unit of the microcontroller 11. In general, the microcontroller 11 is mounted on the main board 10, and pins of the module components M1, M2, M3, . . . , and Mn are connected to a pin of the main board 10. In rare cases, pins of the module components M1, M2, M3, . . . , and Mn and a pin of the microcontroller 11 may be directly connected to each other. Because the program development system of the present disclosure allows the hardware configuration to include assigning the input/output units of the module components M1, M2, M3, . . . , and Mn to the input/output unit of the microcontroller 11, efficiency in various development cases may be improved.

The hardware configuration through the user interface I100 will be described in more detail. When the module selecting unit 110 selects the module component M1 from among the module components M1, M2, M3, . . . , and Mn, the user interface I100 for performing a specific hardware configuration according to the selected module component M1 may be displayed. The user interface I100 may include an area I110 for performing pin assignment and an area I120 showing detailed information of the selected module component M1. In the area I110 for pin assignment may include an interface I111 for designating a main board pin corresponding to each pin of a module component. The area I120 showing detailed information of the selected module component M1 may include information including a category, a model, a manufacturer, a function, a shop etc. of the selected module component M1. When the area I120 showing the detailed information is clicked using a mouse or the like, a more detailed data sheet of the module component M1 may be linked and may be provided.

Also, the module setting unit 120 may enable only a pin of the main board 10 or the microcontroller 11 assignable to a pin of the selected module component M1 to be selected. For example, when ‘Row1’ is assigned as shown in FIG. 4, because ‘Row1’ is a digital output in, only a digital input pin may be selected as a pin of the main board 10 or the microcontroller 11. A VCC, GND, or analog pin is not selected. A conventional method of comparing data sheets and writing a code as text may make a mistake of assigning the digital output pin ‘Row1’ to an analog input pin whereas the preset disclosure may significantly reduce the risk of making such as mistake.

Because the total number of pins of the main board 10 is generally greater than the total number of pins of one of the module components M1, M2, M3, . . . , and Mn, a method of assigning one of the pins of the main board 10 to one pin of a selected module component may be performed.

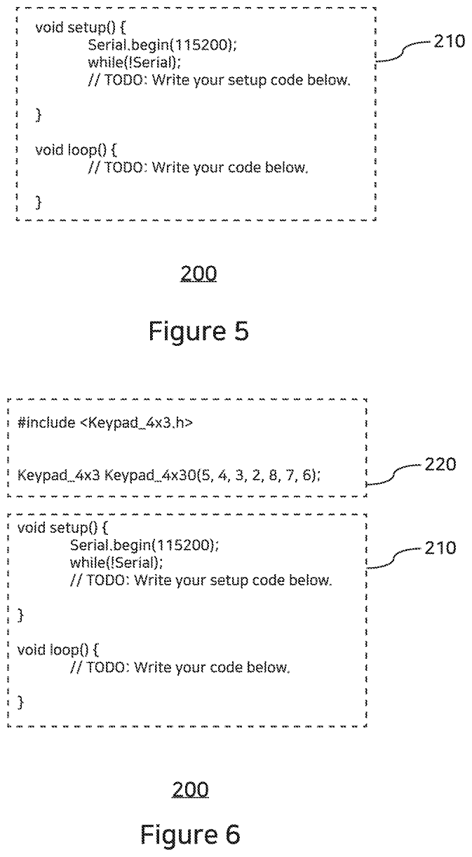

FIG. 5 is a diagram illustrating a driving code according to an embodiment of the present disclosure. A driving code 200 of FIG. 5 is an initial driving code 210 that selects only a type of the main board 10 in the program development system 100 and does not connect the module components M1, M2, M3, . . . , and Mn.

FIG. 6 is a diagram illustrating a driving code into which a driving code generated by the code generating unit 140 is inserted according to an embodiment of the present disclosure. The driving code 200 of FIG. 6 is a driving code into which the initial driving code 210 and a driving code 220 generated by the code generating unit 140 are inserted. The code generating unit 140 may generate the driving code 220 in which a hardware configuration input by the module setting unit 120 is reflected. Referring to FIGS. 4 and 6, it may be found that a hardware configuration involving assigning pins 5, 4, 3, 2, 8, 7, and 6 of the main board 10 to pins Row1, Row2, Row3, Row4, Col1, Col2, and Col3 of a keypad module component Keypad 4×30 is reflected in the driving code 220. The driving code 220 may include a code for using a pre-defined function related to the selected keypad module component Keypad_4×30 (see FIGS. 4 and 6). ‘# include <Keypad_4×3.h>’ in the driving code 220 of FIG. 6 is a code for connecting the driving code 200 and a module code to use a function defined in the module code related to the keypad module component in the driving code 200. The code generating unit 140 may generate the code for connecting the module code to the driving code 200 to connect the driving code 200 and the module code and enabling the function defined in the module code to be easily used in the driving code 200.

The generation of the driving code 220 by the code generating unit 140 may be automatically performed when the hardware configuration of the module setting unit 120 is completed. Because the driving code 220 in which the hardware configuration is reflected is automatically generated when pin assignment is completed through the user interface I100, a developer may immediately check the driving code 220 and may immediately use the function included in the module code.

The driving code 220 generated by the code generating unit 140 of FIG. 6 is not limited to a code illustrated in FIG. 6, and modifications or additions may be made in accordance with characteristics of the module components M1, M2, M3, . . . , and Mn and. Also, the driving code 220 may be generated by being included in the initial driving code 210.

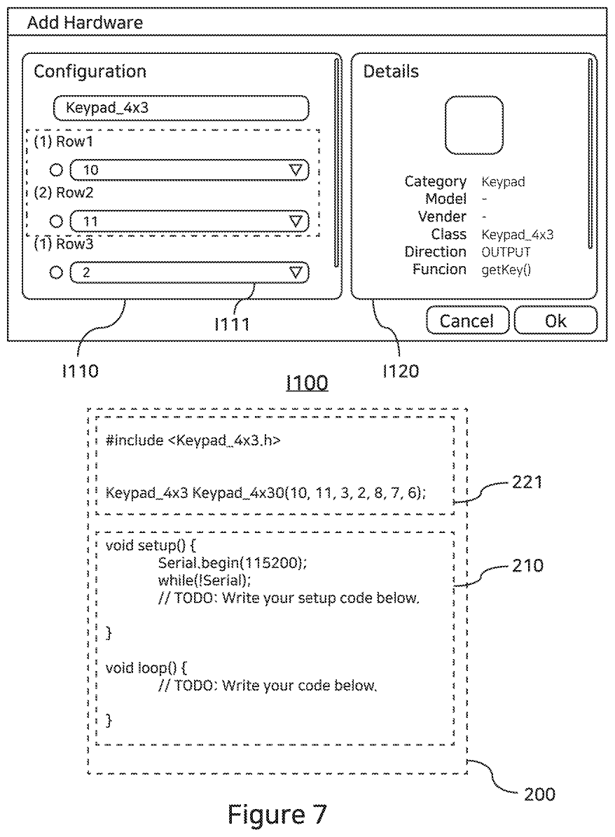

FIG. 7 is a diagram illustrating a change in a driving code according to a change in a hardware configuration.

Referring to FIG. 7, when a hardware configuration is changed, the program development system 100 according to an embodiment of the present disclosure may change the driving code 220. In more detail, pin assignment according to a hardware configuration of FIG. 4 may be performed by assigning the pins Row1, Row2, Row3, Row4, Col1, Col2, and Col3 to the pins 5, 4, 3, 2, 8, 7, and 6 of the main board 10. Accordingly, it may be found that pin assignment to the pins 5, 4, 3, 2, 8, 7, and 6 is reflected in the driving code 220 of FIG. 6. In this case, when the pins Row1 and Row2 of the keypad module Keypad_4×30 are changed to be assigned to pins 10 and 11 of the main board 10 through the user interface I110 as shown in FIG. 7, the code generating unit 140 may change or modify the driving code 220 that is already generated to a modified driving code 221 of FIG. 7 according to the changed pin assignment.

A developer repeatedly performs designing and programming on many module components in a process of developing the hardware device 1. In the repeated process, because data sheets are compared every time and hardware settings and code creation are also repeatedly performed, there is a big waste of time. Also, a code is likely to be incorrectly written in the repeated process. Although the incorrect code is generally corrected during debugging, there is also a waste of debugging time in many cases. Inefficient use of resources in the process of developing the hardware device 1 may be prevented.

Also, according to the present disclosure, instead of simply generating a code, information about different module components M1, M2, M3, . . . , and Mn according to a type of the main board 10, basic settings, and a module code that is frequently used may be stored in the library unit 130, and the developer may simply perform a hardware configuration by using a user interface. Because the hardware configuration may be automatically reflected in a driving code and the developer may easily use a function for a module component, a correction time and resources according to module replacement may be saved.

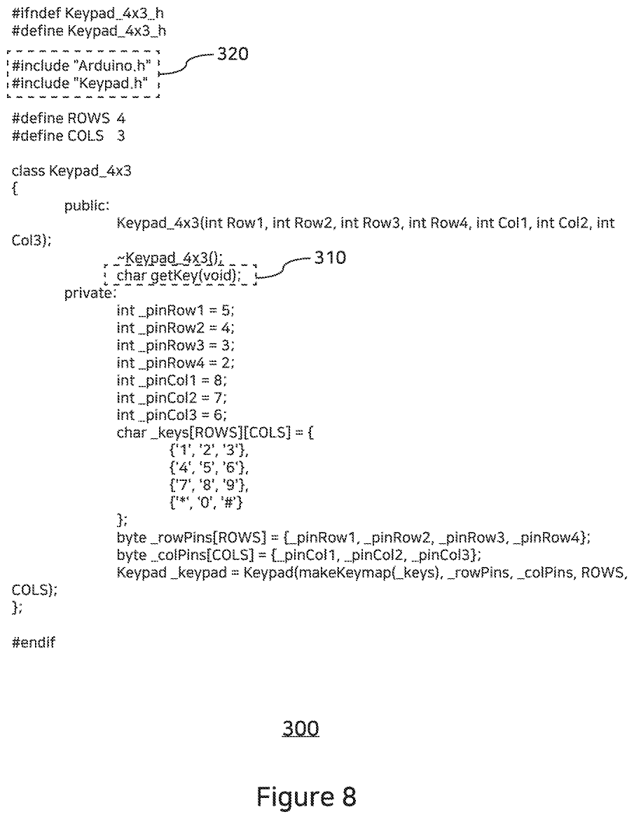

FIG. 8 is a diagram illustrating a module code connected to the generated driving code of FIG. 6 according to an embodiment of the present disclosure.

Referring to FIG. 8, a module code 300 may be a code pre-written to easily use a code (a variable, a function, or a data type definition and declaration) for controlling a module component to be connected in a driving code. A module code connected to ‘# include <Keypad_4×3.h>’ in the driving code 220 generated by the code generating unit 140 of FIG. 6 is illustrated in FIG. 8. As shown in FIG. 8, due to the driving code 220, a class of the module component Keypad_4×3 may be used and a function ‘getKey( )’ 310 defined in the module code 300 may be immediately used in the driving code 200. Also, there may exist another module code 320 continuously connected even in the module code 300. All functions that control a corresponding module component may be used by using only the driving code 220 generated with a simple hardware configuration due to the module code 320 dependently connected in the module code.

The module code 300 may prevent a developer from separately writing each module component in order to use the module component, thereby reducing a waste of resources. The module code 300 is not limited to that of FIG. 8, and may include various other codes. For example, information of a module component may be stored in a JavaScript Object notation (JSON) format, and may be displayed in a hardware configuration. Accordingly, the term ‘module code’ has a broader meaning than that of modular programming used in programming, and may include any file or code that uses or may use a module component in the main board 10.

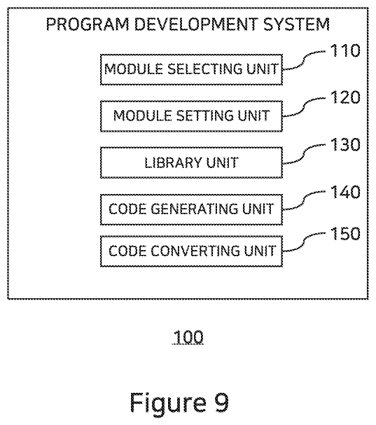

FIG. 9 is a block diagram of a program development system further including a code converting unit according to an embodiment of the present disclosure.

Referring to FIG. 9, the program development system 100 may further include a code converting unit 150 for converting the driving code 200 into a code compatible with the main board 10 or the microcontroller 11, according to the main board 10 or the microcontroller 11.

When the main board 10 or the microcontroller 11 is changed, the code converting unit 150 may change a module code connected to the driving code 200 into a module code suitable for the changed main board 10 or microcontroller 11. For example, when a main board on which Atmega128 is mounted is changed into a main board on which ARM M0 is changed, the code converting unit 150 may change a module code written to be suitable for Atmega128 into a module code suitable for ARM M0. The code generating unit 140 may modify the module code 300 so that the changed module code is used in the driving code 200. For example, for module component input/output pins using atmega128 input/output pins, suitable input/output ARM M0 input/output pins may be selected and automatically assigned. In this process, when the number of input/output pins is less than that of the existing microcontroller 11, or when a function, for example, an analog-digital converter pin, which is present in the existing microcontroller 11 is not present in the changed microcontroller, the changed microcontroller is not suitable, and thus an alarm may be provided to a user.

The driving code 220 that is previously generated is generated to use a module code set according to the main board 10 that is selected. Accordingly, when a developer changes the main board 10 during development, the driving code 200 that is previously written may not be used. In this case, development has to be started from scratch. However, because the code converting unit 150 changes a module code into a module code suitable to the changed main board 10 or microcontroller 11, the developer may continuously perform a development project of developing the hardware device 1.

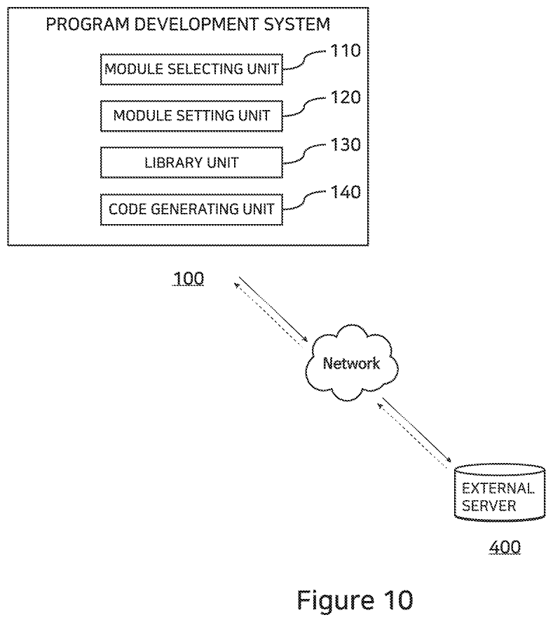

FIG. 10 is a block diagram of a program development system connected to a network according to an embodiment of the present disclosure.

Referring to FIG. 10, the library unit 130 may store a module code in an external server 400 connected to a network. Also, the library unit 130 may retrieve the module code in the external server 400 through the network. Even when there are no module components M1, M2, M3, . . . , and Mn necessary for a developer from among the module components M1, M2, M3, . . . , and Mn registered in the program development system 100, the module code stored in the external server 400 connected through the network may be retrieved and the module components M1, M2, M3, . . . , and Mn necessary for the developer may be registered in the program development system 100. Due to the external server 400, the program development system 100 connected to the network does not need to have a large amount of data of the module code for the module components M1, M2, M3, . . . , and Mn and may fetch only data of the necessary module components M1, M2, M3, . . . , and Mn, the program development system 100 may be optimized.

Also, the developer may instantly respond by updating a module code for a module component that is newly released.

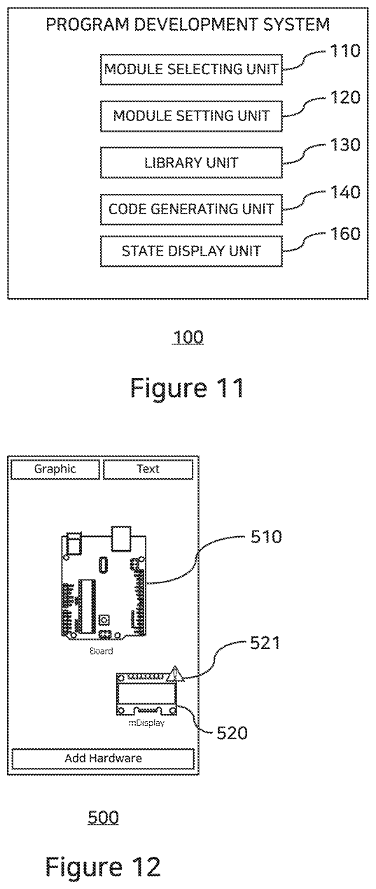

FIG. 11 is a block diagram of a program development system including a state display unit according to an embodiment of the present disclosure. FIG. 12 is a diagram illustrating graphics on the state display unit according to an embodiment of the present disclosure.

Referring to FIGS. 11 and 12, the program development system 100 according to an embodiment of the present disclosure may include a state display unit 160 for displaying as graphics a connection state between the main board 10 and the module components M1, M2, M3, . . . , and Mn connected to the main board 10. Graphic 500 displayed by the state display unit 160 may include a main board graphic 510 and a connected module component graphic 520.

The connection state may be an assignment state between pins of the module components M1, M2, M3, . . . , and Mn connected to the main board 10 and pins of the main board 10 assigned to the pins of the module components M1, M2, M3, . . . , and Mn. The connection state may include a state where pin assignment is completed, a state in which the pins of the main board 10 are redundantly assigned, a state where the pins of the main board 10 are not assigned, and a state where the pins of the main board 10 that are not compatible are assigned.

The state display unit 160 may display an alarm according to the connection state. The alarm may be displayed at positions of the module components M1, M2, M3, . . . , and Mn connected to the main board 10. The alarm may be displayed or output in various forms. For example, the alarm may be displayed as a badge icon 521 having a color. A color or a shape of the badge icon 521 may vary according to the connection state so that the developer is able to recognize the connection state of the connected module components. The badge icon 521 may be displayed on the connected module component graphic 520 as shown in FIG. 11, and may vary depending on the connection state. The state where pin assignment is completed may be displayed in green, the state where the pins of the main board 10 are redundantly assigned to one or more pins from among the pins of the connected module components may be displayed in yellow, the state where the pins of the main board 10 are not assigned to one or more pins from among the pins of the connected module components may be displayed in gray, and the state where the pins of the main board 10 that are not compatible are applied to one or more pins from among the pins of the connected module components may be displayed in red.

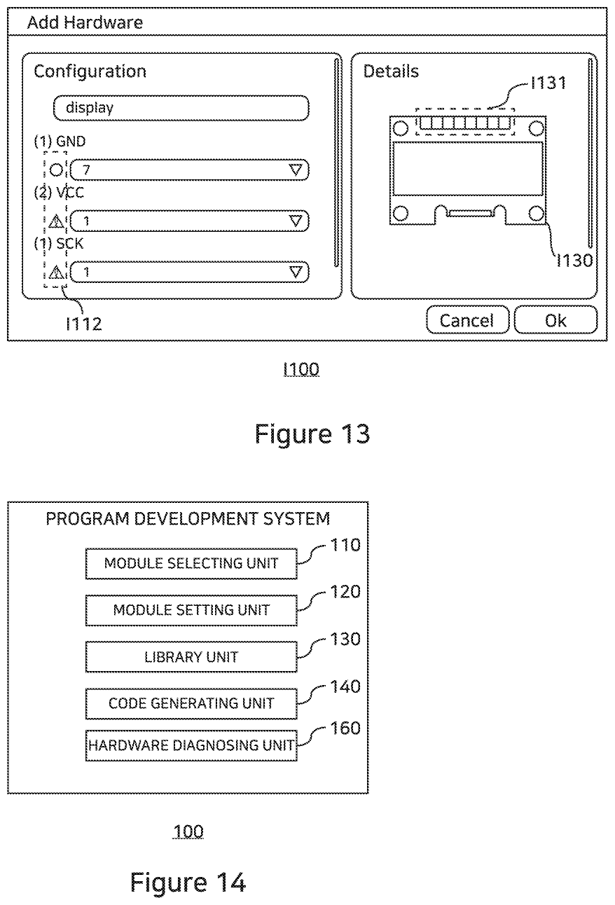

FIG. 13 is a diagram illustrating an alarm of a pin that is redundantly assigned in a hardware configuration process according to an embodiment of the present disclosure.

Referring to FIG. 13, when a hardware configuration of a module component is performed, the state display unit 160 of FIG. 11 may display a graphic 1130 of the module component. An alarm may also be displayed on the graphic 1130 of the module component displayed in a hardware configuration process. An alarm 1131 may be displayed at a position of a pin of the module component that is redundantly assigned in the graphic 1130 of the module component. This process may be performed in association with the module setting unit 120. The module setting unit 120 may provide an alarm 1112 when each pin of the module component is redundantly assigned to each pin of the main board 10 or the microcontroller 11 so that a developer recognizes a connection state of the pin in a pin assignment process. Also, when the alarm 1131 is displayed on the pin that is redundantly assigned in the graphic 1130 of the module component displayed by the state display unit 160 and a focus of an input device is on the alarm 1131, a pin assignment interface may appear at the position and the module setting unit 120 may cause pin assignment modification to be immediately performed. For example, the pin that is redundantly assigned in the graphic 1130 of the module component may be displayed in yellow. When the developer moves a mouse cursor of a mouse to the pin displayed in yellow, and the cursor is located at the position or a predetermined condition is satisfied, an interface for pin assignment may pop up. The developer may check in real time the connection state for pin assignment displayed in graphics, and may more intuitively recognize and solve a problem with the connection state. Frequent mistakes of redundantly assigning a pin of a module component to a pin of the main board 10 due to the characteristics of programming written in text may be reduced or avoided.

An alarm is not limited to a badge icon, and may be of any type as long as the developer may recognize a connection state.

FIG. 14 is a block diagram of a program development system including a hardware diagnosing unit according to an embodiment of the present disclosure.

Referring to FIG. 14, the program development system 100 according to an embodiment of the present disclosure may include a hardware diagnosing unit 170 for updating a diagnostic program that is pre-written to diagnose a connection state of the hardware device 1 to the hardware device 1.

A program for testing the hardware device 1 that is completed is installed in the hardware diagnosing unit 170. The hardware diagnosing unit 170 may update a test program installed in the hardware device 1 and may enable the test program to drive the hardware device 1. The test program is a program for checking a connection state between one or more module components included in the hardware device 1 and the main board 10 or the microcontroller 11. For example, when a display module and a speaker module are mounted on the hardware device 1, the test program updated by the hardware diagnosing unit 170 may cause a simple image or text to be output from the display module mounted on the hardware device 1 and a sound to be output from the speaker module. In a development process of the hardware device 1, an error does not occur during debugging, but abnormal operations often occur in the hardware device 1. This is because there is no error in a code, but there is abnormal physical connection between the main board 10 and the microcontroller 11 and the module components. Although this seems to be a simple problem, in a real development environment, the developer tends to find a problem with the code without even thinking about a physical connection state. The hardware diagnosing unit 170 may simply solve the problem and may reduce a time inefficiently spent developing the hardware device 1.

A program development method using the program development system 100 will now be described. A detailed explanation of each step of the program development method is the same as that of the program development system 100 and thus will be given briefly.

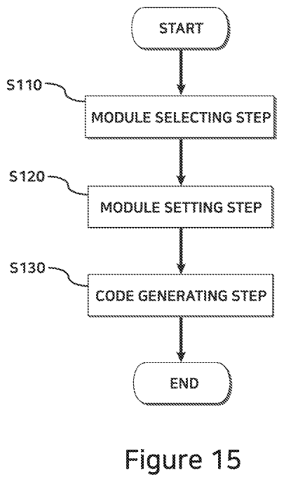

FIG. 15 is a flowchart of a program development method according to an embodiment of the present disclosure.

Referring to FIG. 15, a program development method using a program development system for driving a hardware device including a main board on which a microcontroller is mounted and one or more module components electrically connected to the main board may include a module selecting step S110, a module setting step S120, and a code generating step S130.

The module selecting step S110 may be a step of selecting a module component to be connected to the main board.

The module setting step S120 may be a step of inputting a hardware configuration of the module component selected in the module selecting step S110 through a user interface. The hardware configuration may include assigning each pin of the selected module component to each pin of the main board or the microcontroller. Also, in the module setting step S120, when each pin of the module component is redundantly assigned to each pin of the main board or the microcontroller, an alarm may be provided.

The code generating step S130 may be a step of generating a driving code for driving the hardware device. The code generating step S130 may be a step of automatically generating the driving code by using the module component and a pre-written module code and automatically reflecting the hardware configuration input in the module setting step S120 in the driving code.

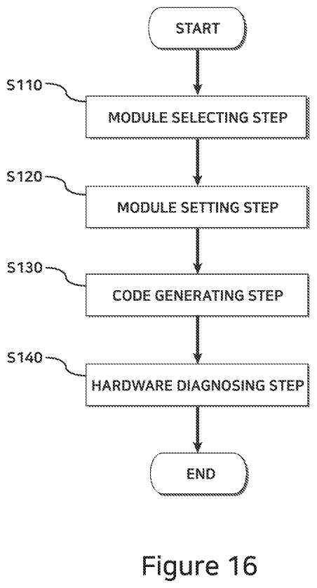

FIG. 16 is a flowchart of a program development method including a hardware diagnosing step according to an embodiment of the present disclosure.

Referring to FIG. 16, after the code generating step S130 of FIG. 15, a program development method may further include a hardware diagnosing step S140. The hardware diagnosing step S140 may be a step of uploading a diagnostic program that is pre-written to diagnose a connection state of the hardware device to the hardware device.

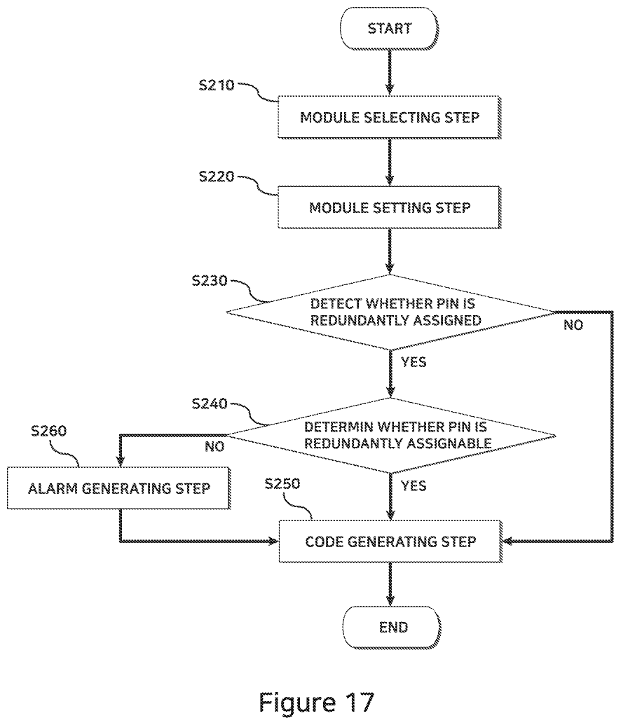

FIG. 17 is a flowchart of a program development method including a redundant pin assignment detecting step according to an embodiment of the present disclosure.

Referring to FIG. 17, a program development method may include a module selecting step S210 of selecting a module component, and a module setting step S220 of assigning pins of a main board to the selected module component. After the module setting step S220, the program development method may include a step S230 of detecting whether there is a pin that is redundantly assigned from among the pins of the main board assigned to each pin of the module component. When there is no pin that is redundantly assigned from among the assigned pins of the main board, the program development method may proceed to a code generating step S250. When there is a pin that is redundantly assigned, the program development method may proceed to a step of S240 of determining whether the pin that is redundantly assigned is a pin that is redundantly assignable or not. For example, when the pin that is redundantly assigned is a pin related to network communication of the main board such as a controller area network (CAN)-bus or a pin such as VCC or GND, the pin may be redundantly assigned to another module, and thus an alarm may not be provided and the program development method may proceed to the code generating step S250. When the pin that is redundantly assigned is a pin related to data input/output of a microcontroller, the pin may not be redundantly assignable when another module already occupies and uses the pin. In this case, the program development method may proceed to an alarm generating step S241 of generating an alarm indicating that redundant assignment has occurred through a module setting unit and a state display unit. Even when redundant assignment occurs after the alarm generating step S241, the program development method may proceed to the code generating step S250 to generate a driving code. When a developer checks the alarm regarding the redundant assignment and changes pin assignment through a user interface, a code generating unit may change the driving code by reflecting the changed pin assignment. Alternatively, the developer may change the pin assignment by directly changing a text code. When the developer directly changes the text code, the module setting unit may check the changed text code and may perform again a step of checking whether there is a pin that is redundantly assigned in the changed pin assignment.

In the above, because a pin that is redundantly assigned may be detected in a coding step earlier than a step of the prior art in which a developer uploads a program to a hardware device and detects a pin that is redundantly assigned, a waste of time may be reduced. Because the developer does not need to check and review a data sheet to determine whether the pin is a redundantly assignable pin, a development speed may be increased.

A hardware development system and a development method using the same according to the present disclosure may build a database of module codes of module components in a hardware device development stage and may automatically perform a setting operation between the module component and a main board by using simple pin assignment through a user interface.

Also, a hardware development system and a development method using the same according to the present disclosure may enable only a module component and a pin of the module component compatible with a main board to be selected, and thus may reduce trials and errors in a development stage and reduce a waste of time and resources.

Various embodiments described herein may be implemented in hardware, middleware, microcode, software, and/or any combination thereof. For example, various embodiments may be implemented within one or more application-specific integrated circuits (ASICs), digital signal processors (DSPs), digital signal processing devices (DSPDs), programmable logic devices (PLDs), field-programmable gate arrays (FPGAs), processors, controllers, microcontrollers, microprocessors, other electronic units designed to perform the functions described herein, or a combination thereof.

Also, for example, various embodiments may be stored or encoded in a computer-readable medium including instructions. The instructions stored or encoded in the computer-readable medium may enable a method to be performed by a programmable processor or another processor when, for example, the instructions are executed. Computer-readable media include both computer storage media and communication media including any medium that facilitates transfer of a computer program from one place to another. A storage medium may be any available medium that may be accessed by a computer. By way of example, such computer-readable media may include random-access memory (RAM), read-only memory (ROM), electrically erasable programmable read-only memory (EEPROM), compact disk (CD)-ROM or other optical disk storage, magnetic disk storage or other magnetic storage devices, or any other medium that may be used to carry or store desired program code in the form of instructions or data structures and that may be accessed by a computer.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various components in the embodiments described above should not be understood as requiring such separation in all embodiments, and it should be understood that the described components may be generally be integrated together in a single software product or packaged into multiple software products.

While the present disclosure has been particularly shown and described with reference to embodiments thereof, they are provided for the purposes of illustration and it will be understood by one of ordinary skill in the art that various modifications and equivalent other embodiments may be made from the present disclosure. Accordingly, the true technical scope of the present disclosure is defined by the technical spirit of the appended claims.

What is claimed is:

1. A program development system for driving a hardware device comprising a main board on which a microcontroller is mounted and at least one module component electrically connected to the main board, the program development system comprising:
a module selecting unit configured to select the module component through a user interface;
a module setting unit configured to input, through the user interface, a hardware configuration of the module component selected by the module selecting unit;
a library unit configured to store a module code related to the module component; and
a code generating unit configured to generate a driving code for driving the hardware device,
wherein the code generating unit is further configured to automatically generate the driving code by using the module code stored in the library unit, and automatically reflect the hardware configuration input by the module setting unit in the driving code.

2. The program development system of claim 1, wherein the hardware configuration comprises assigning each pin of the selected module component to each pin of the main board or the microcontroller.

3. The program development system of claim 2, wherein, when the pin of the main board or the microcontroller assigned to the pin of the selected module component is changed, the module code is changed according to changed pin assignment.

4. The program development system of claim 2, wherein the module setting unit allows only a pin of the main board or the microcontroller that is assignable to the pin of the selected module component to be selected.

5. The program development system of claim 1, wherein the hardware configuration comprises assigning an input/output unit of the module component to an input/output unit of the microcontroller.

6. The program development system of claim 1, wherein the module code is automatically generated when the hardware configuration is completed in the module setting unit.

7. The program development system of claim 1, wherein the module selecting unit allows only a module component compatible with a type of the main board to be selected.

8. The program development system of claim 1, further comprising a code converting unit configured to change the driving code that is written into a code compatible with the main board or the microcontroller, according to the main board or the microcontroller.

9. The program development system of claim 1, wherein the library unit is further configured to store the module code in an external server connected to a network.

10. The program development system of claim 1, further comprising a state display unit configured to display as graphics a connection state between the main board and the module component connected to the main board.

11. The program development system of claim 10, wherein the hardware configuration comprises assigning each pin of the selected module component to each pin of the main board or the microcontroller,
wherein the module setting unit is further configured to provide an alarm when each pin of the module component is redundantly assigned to each pin of the main board or the microcontroller.

12. The program development system of claim 11, wherein the alarm is generated when the pin of the main board or the microcontroller is selected for the pin of the selected module component.

13. The program development system 12, wherein the alarm is displayed on the state display unit at a position of a pin that is redundantly assigned.

14. The program development system of claim 1, further comprising a hardware diagnosing unit configured to upload a diagnostic program, which is pre-written to diagnose a connection state of the hardware device, to the hardware device.

15. A program development system for driving a hardware device comprising a main board on which a microcontroller is mounted and at least one module component electrically connected to the main board, the program development system comprising:
a module selecting unit configured to select the module component;
a module setting unit configured to set each pin of the module component selected by the module selecting unit to each pin of the microcontroller or the main board through a user interface; and
a code generating unit configured to automatically generate a driving code for driving the hardware device comprising the module component selected by the module selecting unit,
wherein the code generating unit is further configured to generate the driving code by using information of each pin of the module component set by the module setting unit.

16. The program development system of claim 15, wherein each pin of the module component and each pin of the microcontroller or the main board are pins related to input/output.

17. A program development method using a program development system for driving a hardware device comprising a main board on which a microcontroller is mounted and at least one module component electrically connected to the main board, the program development method comprising:
a module selecting step of selecting the module component;
a module setting step of inputting, through a user interface, a hardware configuration of the module component selected in the module selecting step; and
a code generating step of generating a driving code for driving the hardware device,
wherein the code generating step comprises automatically generating the driving code by using a pre-written module code related to the module component and automatically generating the hardware configuration input in the module setting step in the driving code.

18. The program development method of claim 17, wherein the hardware configuration comprises assigning each pin of the selected module component to each pin of the main board or the microcontroller.

19. The program development method of claim 17, wherein the hardware configuration comprises assigning each pin of the selected module component to each pin of the main board or the microcontroller,
wherein the module setting step comprises providing an alarm when each pin of the module component is redundantly assigned to each pin of the main board or the microcontroller.

20. The program development method of claim 17, further comprising a hardware diagnosing step of uploading a diagnostic program, which is pre-written to diagnose a connection state of the hardware device, to the hardware device.

21. A computer-readable recording medium having embodied thereon a program for executing the method of claim 17.
